(19) United States
(12) Patent Application Publication
(10) Pub. No.: US 2017/0372306 A1
(43) Pub. Date: Dec. 28, 2017

(54) PAYMENT BY MOBILE DEVICE SECURED BY F-PUF

(71) Applicant: SAMSUNG ELECTRONICS CO., LTD., SUWON-SI (KR)

(72) Inventors: MICHAEL KARA-IVANOV, RAMAT GAN (IL); ANATOLY LITOVSKY, RAMAT GAN (IL); JUN JIN KONG, YONGIN-SI (KR); SHMUEL DASHEVSKY, HWASUNG-SI (KR)

(21) Appl. No.: 15/193,168

(22) Filed: Jun. 27, 2016

(51) Int. Cl. G06Q 20/38; H04W 12/04; H04L 9/32; H04L 9/30; H04L 9/14; H04L 29/06; G06Q 20/32; H04W 12/06; G06Q 20/40

(52) U.S. Cl. CPC G06Q 20/3829; H04W 12/06; H04W 12/04; H04L 9/3278; G06Q 20/40145; H04L 9/14; H04L 63/0823; H04L 63/06; G06Q 20/322; H04L 9/3263; H04L 9/30; G06Q 2220/00; H04L 2209/56; H04L 2209/80

(57) ABSTRACT

A method, executed by a processor of a mobile communication device, for authenticating a purchase transaction includes receiving a certificate from a purchase agent and authenticating the purchase transaction based upon a comparison outcome of the certificate and a Flash Physical Unclonable Function (F-PUF) of a nonvolatile memory device integrated within the mobile communication device.

### BACKGROUND

### 1. Technical Field

The present disclosure relates to the use of a physical unclonable function (PUF) of a nonvolatile memory to secure payments made by a mobile device.

### 2. Description of the Related Art

Traditionally, people have paid for the purchase of goods or services by: (1) goods or cash, (2) providing credit card information via telephone or swiping the credit card in a payment device of a specific shop, or (3) writing a check. A credit card has certain advantages in comparison with other forms of payment; however, the credit card number is a vulnerable object and can be stolen and used maliciously for a long time without the knowledge of its owner.

Recent payment protocols are using near-field communication (NFC), which can support communication with a payment device by bringing an end-user's mobile device (MD) in close proximity to, or touch with, the payment device. Modern MDs enable their owners to purchase the merchandise on-line. These transactions can be performed by a preloaded software application (SWA) that contains the user's credentials. At some point, a user supplies his/her secret personal identification number (PIN), which can be used for the user authentication. In some of these protocols SWA is the most vulnerable point for a pirate attack, as both the user's credentials and the PIN can be extracted by malicious pirate SW and afterwards used by a pirate, even without the user's knowledge.

### SUMMARY

An object of the disclosure is to improve and secure payment with a mobile device and also to secure near-field communication (NFC), related to mobile device functionality. These and other objects of the disclosure may be obtained by embodiments disclosed herein.

An example embodiment of the disclosure provides a method, executed by a processor of a mobile communication device, of authenticating a purchase transaction. The method includes receiving a certificate from a Purchase Agent (PA) and authenticating the purchase transaction based upon a comparison outcome of the certificate and a Flash Physical Unclonable Function (F-PUF) measurement of a nonvolatile memory or another electronic circuit chip integrated within the mobile communication device. The PA is an intermediate between a Vendor, which is the producer of the goodies, between the bank account of the Purchaser and between the Purchaser himself. In some scenarios, the PA represents the shop, supermarket or distributor of the goodies, which in fact sells the item to the Purchaser. A Certificate binds the initial response of the Purchaser's mobile device (this initial response is produced in the secure room upon flash manufacturing) with a Purchaser's name and ID, and this Certificate is signed by the Private Key of the Trusted Authority (which can be a state, bank or a big company). In some instances, the Certificate can be encrypted by a PA key to prevent a pirate from reading and stealing the Certificate's content. The decryption of this Certificate can happen inside the mobile device of the Purchaser.

In an exemplary embodiment, the certificate received from the PA is signed with a private key of the Trusted Authority. The method may further include, prior to authenticating the purchase transaction, retrieving a public key (corresponding to the private key of the Trusted Authority) from the nonvolatile memory of mobile device, and validating the signed and decrypted certificate with the public key. The public key in this case is stored in a Read-Only or locked area, which cannot be changed by a pirate.

The method may further include receiving a software application (SWA) from the PA and executing the received software application, wherein the executed software application authenticates the purchase transaction based upon the comparison outcome of the Certificate and the F-PUF measurement. In some implementations comparison of the signed data inside the Certificate with the F-PUF measurement may be viewed as an additional security mechanism, which provides enhancement or substitution for the classical encryption and signature validation techniques, which provide integrity and security protection of the purchase transaction.

In the alternative implementations F-PUF together with helper data (stored in non-volatile memory) may provide the permanent secret private key of the device, which will be used by the SWA to sign the purchase transaction. This signature will be checked by the public key, stored in the PA or in a Bank together with a Certificate, binding this public key with a name of the Purchaser and the ID of his mobile device. As in the described above case, this Certificate will be signed by the Private Key of the Trusted Authority (which can be a state, bank or a big company).

In some implementations, the PA or Bank may decide (instead of checking the certificates) to keep a DataBase with the data, binding the above mentioned public key with a name of the Purchaser and the ID of his mobile device.

The method may further include validating the signed software application prior to executing the software application.

The method may further include communicating a message to the purchase agent, wherein the certificate is received from the purchase agent in response to the message.

The method may further include communicating a message to the purchase agent, wherein the software application is received from the purchase agent in response to the message.

The method may further include requesting a user of the mobile communication device to provide secure identification information, upon authenticating the purchase transaction.

In an exemplary embodiment, the secure identification information includes biometric information of the user.

Another example embodiment of the disclosure provides a mobile communication device that authenticates a purchase transaction. The mobile communication device includes a nonvolatile memory comprising a Flash Physical Unclonable Function (F-PUF) and a processor that retrieves the F-PUF from the nonvolatile memory, receives a certificate from a purchase agent, and authenticates the purchase transaction based upon a comparison outcome of the certificate and the F-PUF.

In an exemplary embodiment, the certificate received from the purchase agent is signed with a private key of the purchase agent, the nonvolatile memory stores a public key corresponding to the private key, and the processor, prior to authenticating the purchase transaction, retrieves the public key from the nonvolatile memory and validates the signed certificate with the public key.

In an exemplary embodiment, the processor receives a software application from the purchase agent and executes the received software application. The executed software application may authenticate the purchase transaction based upon the comparison outcome of the certificate and the F-PUF.

In an exemplary embodiment, the software application received from the purchase agent is signed with a private key of the purchase agent, the nonvolatile memory stores a public key corresponding to the private key, and the processor retrieves the public key from the nonvolatile memory and validates the signed software application with the public key.

In an exemplary embodiment, the processor validates the signed software application prior to executing the software application.

In an exemplary embodiment, the processor communicates a message to the purchase agent, and receives the certificate from the purchase agent in response to the message.

In an exemplary embodiment, the processor communicates a message to the purchase agent, and receives the software application from the purchase agent in response to the message.

In an exemplary embodiment, the processor requests a user of the mobile communication device to provide secure identification information, upon authenticating the purchase transaction.

In an exemplary embodiment, the secure identification information includes biometric information of the user.

Still another example embodiment of the disclosure provides a non-transitory computer readable medium having instructions that when executed by a processor of a mobile communication device cause the processor to implement a method of authenticating a purchase transaction. The method includes receiving a certificate from a purchase agent and authenticating the purchase transaction based upon a comparison outcome of the certificate and a Flash Physical Unclonable Function (F-PUF) of a nonvolatile memory device integrated within the mobile communication device.

In an exemplary embodiment, the certificate received from the purchase agent is signed with a private key of the purchase agent. The method may further include, prior to authenticating the purchase transaction, retrieving a public key corresponding to the private key from the nonvolatile memory and validating the signed certificate with the public key.

### BRIEF DESCRIPTION OF THE DRAWINGS

The accompanying drawings are included to provide a further understanding of the present disclosure, and are incorporated in and constitute a part of this specification. The drawings illustrate example embodiments of the present disclosure and, together with the description, serve to explain principles of the present disclosure. In the drawings:

FIG. 1 illustrates a mobile device that validates a purchase agent's credentials according to an embodiment of the disclosure; and

FIG. 2 illustrates a method of authorizing a purchase according to an embodiment of the disclosure.

### DETAILED DESCRIPTION OF EMBODIMENTS

The advantages and features of the present disclosure and methods of achieving them will be apparent from the following example embodiments that will be described in more detail with reference to the accompanying drawings. It should be noted, however, that the present disclosure is not limited to the following example embodiments, and may be implemented in various forms. Accordingly, the example embodiments are provided only to disclose the present disclosure and let those skilled in the art know the concept of the present disclosure.

The terms used in the present disclosure are for the purpose of describing particular embodiments only and are not intended to be limiting of the present disclosure. As used in the specification, the singular forms “a”, “an” and “the” are intended to include the plural forms as well, unless the context clearly indicates otherwise. It will be further understood that the terms “comprises” and/or “comprising”, when used in the present disclosure, specify the presence of stated features, integers, steps, operations, elements, and/or components, but do not preclude the presence or addition of one or more other features, integers, steps, operations, elements, components, and/or groups thereof.

Hereinafter, example embodiments of the present disclosure will now be described more fully with reference to accompanying drawings.

A Flash Physical Unclonable Function (F-PUF) within a nonvolatile memory device of a mobile communication device uniquely identifies the nonvolatile memory device. Such unique identification adds additional security to the use of the user's personal identification number (PIN) and to the use of the user's mobile device in general. More specifically, the additional use of the F-PUF digital fingerprint for a purchase transaction, creates an additional transaction protection layer, and now a pirate is unable to obtain a user's credentials and PIN from the user's mobile device because without F-PUF authentication the transaction cannot occur.

Payment security is increased by using an F-PUF of a flash memory, which resides inside a mobile device. Suppose the user decides to purchase some article which he/she finds on the Internet or finds on the shelf of a shop. Upon selecting the article, the user receives a message identifying the price and name of the article. The mobile device transfers the following to a purchase agent (PA) (e.g., to a bank or to a Purchasing Center): a message with the price and name of the article and a certificate of the flash memory within the mobile device. Afterwards a special software application (SWA) signed by the purchase agent's private key is issued and sent to the user's mobile device. This special SWA is verified by the user's mobile device. Only after the special SWA is verified by the user's mobile device, does the mobile device read the value of the nonvolatile memory's F-PUF, which is stored on the mobile device's flash memory during the manufacture of the flash memory. The mobile device compares the response of the nonvolatile memory's F-PUF with information, stored inside a certificate signed by the purchase agent's private key. Only after a positive comparison is obtained between the F-PUF and the certificate, is the user prompted to enter his/her secret Security PIN (SP), which finalizes the user authentication process. In some embodiments, F-PUF authentication method can be an ISPP method, as is described in detail in the patent “Non-Leaky Helper Data—extracting cryptographic keys from the noisy environment” U.S. patent application Ser. No. 14/699,354, belonging to Samsung. In some embodiments, F-PUF authentication method can use non-leaky helper data or in other embodiments any other helper data, as for example, error correction code, for example, BCH.

The significant advantage of this scheme is that before the final stage of the payment, additional authentication on the part of the mobile device takes place, to ensure that the device, which issues the transaction, is a verified and legal device belonging to the specified and legal user. In addition, pairing of two such devices allows secured peer-to-peer transactions between two independent end-users. Such peer-to-peer transactions may change the purchasing interface in the future, as they allow direct connection between various end users without banking and cash involvement. The use of biometric sensors within latest-generations mobile devices may enhance the final stage of authentication through biometric authentication (BA).

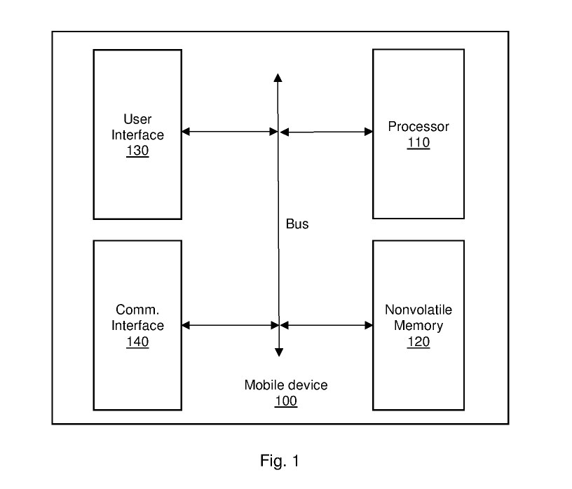

FIG. 1 illustrates a mobile communication device that adds an additional level of authentication according to an embodiment of the disclosure. Mobile communication device 100 includes a processor 110, a nonvolatile memory 120, a user interface 130, and a communication interface 140. Processor 110, nonvolatile memory 120, user interface 130, and communication interface 140 communicate within mobile communication device 100 through a communication bus.

Processor 110 controls the operations of mobile device 100, performs logic processing, and executes various software applications. Processor 110 controls the operations of mobile communication device 100.

Nonvolatile memory 120 provides long-term storage for data accessed by processor 110. Processor 110 writes data to memory locations within nonvolatile memory 120 and reads data from memory locations within nonvolatile memory 120. Nonvolatile memory 120 may be a NAND memory, and the NAND memory may be a NAND flash memory. From this flash memory, an F-PUF digital fingerprint may be extracted. In some embodiments, the flash memory can be a three-dimensional flash memory, like, for example, VNAND.

User interface 130 provides data input and output components for a user to communicate with mobile communication device 100. The input components may include a keyboard, microphone, touchscreen, mouse, etc. The output components may include a display screen, speaker, etc. Processor 110 communicates information to the user through user interface 130 and receives information from the user through user interface 130.

Communication interface 140 communicates information between mobile communication device 100 and external devices via wired or wireless communication. Communication interface 140 supports the appropriate protocols for communicating with the external devices.

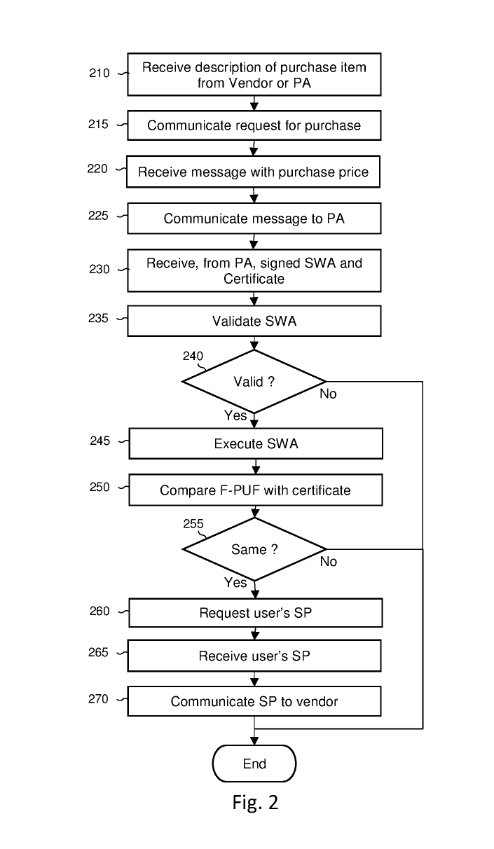

FIG. 2 illustrates a method of authorizing a purchase according to an embodiment of the disclosure. The method illustrated by FIG. 2 may be executed by processor 110, which is illustrated in FIG. 1.

Processor 110 receives 210 a description of an item for purchase from a communication device of a vendor, via communication interface 140. Processor 110 conveys this description to the user through user interface 130. If the user chooses to purchase the item, the user communicates this choice to processor 110 through user interface 130. Upon learning that the purchaser wishes to purchase the item, processor 110 communicates 215 a request to purchase the item to the vendor's communication device through communication interface 140.

The vendor's communication device responds to the purchase request by communicating a message to mobile device 100 that includes an identification of the item and its price. Processor 110 receives 220 this message through communication interface 140. Thereafter, processor 110 communicates 225 a message that includes the identification of the item or indication thereof, the price or an indication of the price of the item, and a certificate of the non-volatile memory 120 to a communication device of a purchase agent (PA) through communication interface 140. In some embodiments, a shortened alternative of the communication 210, 215 and 225 can take place: for example, a description of the purchase item 210 can also contain the price of this item, thus 210 and 220 can comprise one action and not two separate actions.

The purchase agent responds to the message by communicating a software application (SWA) and a certificate to mobile device 100. Each of the software application and certificate are signed with a private key belonging to the purchase agent. Processor 110 receives 230 the signed software application and certificate through communication interface 140.

Processor 110 validates 235 the signed software application and certificate using a public key, which processor 110 retrieves from the Internet and stores in non-volatile memory 120. This public key may be published previously by the PA, and this public key is uniquely related to the private key used for signing the SWA and certificate. The public key may be stored in nonvolatile memory 120 at any time.

Only upon validating 240 the software application, does processor 110 execute 245 the software application, which retrieves a response of a Flash Physical Unclonable Function (F-PUF) from nonvolatile memory 120. Processor 110 compares 250 the F-PUF response with the validated purchase agent certificate to determine whether they are the same. If processor 110 determines 255 the F-PUF and certificate are the same, processor 110 requests 260 a Security Personal-identification-number (SP) from the user. The request for the SP is communicated by processor 110 to the user through user interface 130. The user replies to the request by providing his/her SP through user interface 130, which is received 265 by processor 110. If processor 110 determines 255 the F-PUF and certificate are not the same, the purchase transaction is terminated.

As previously mentioned, processor 110 receives 265 the user's SP through user interface 130 and communicates 270 the SP to the vendor's communication device through communication interface 140. The vendor's communication device finalizes the purchase transaction and terminates the transaction.

A configuration illustrated in each conceptual diagram should be understood just from a conceptual point of view. Shape, structure, and size of each component illustrated in each conceptual diagram are exaggerated or downsized for understanding of the present disclosure. An actually implemented configuration may have a physical shape different from a configuration of each conceptual diagram. The present disclosure is not limited to a physical shape or size illustrated in each conceptual diagram.

The device configuration illustrated in each block diagram is provided to help convey an understanding of the present disclosure. Each block may include smaller blocks according to functions. Alternatively, a plurality of blocks may form a larger block according to a function. That is, the present disclosure is not limited to the components illustrated in each block diagram.

The operations illustrated in the drawings are illustrative of one or more embodiments of the disclosure, but are not limited to the sequence illustrated. Some operations may be omitted and additional operations may be included in embodiments of the disclosure. Also, the sequence of the operations may be changed and some operations may be performed either simultaneously or in sequence.

As is traditional in the field of this art, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The disclosure presented in U.S. application Ser. No. 15/080,070 is incorporated herein in its entirety.

While the present disclosure has been particularly shown and described with reference to example embodiments thereof, the present disclosure is not limited to the above-described example embodiments. It will be understood by those of ordinary skill in the art that various changes and variations in form and details may be made therein without departing from the spirit and scope of the present disclosure as defined by the following claims.

What is claimed is:

1. A method, executed by a processor of a mobile communication device, of authenticating a purchase transaction, the method comprising:
receiving a certificate from a purchase agent; and
authenticating the purchase transaction based upon a comparison outcome of the certificate and a Flash Physical Unclonable Function (F-PUF) of a nonvolatile memory or another electronic circuit chip integrated within the mobile communication device.

2. The method of claim 1, wherein:
the certificate received from the purchase agent is signed with a private key of the purchase agent, and
the method further comprises, prior to authenticating the purchase transaction, retrieving a public key, from the nonvolatile memory, corresponding to the private key and validating the signed certificate with the public key.

3. The method of claim 1, further comprising:
receiving a software application from the purchase agent; and
executing the received software application, wherein
the executed software application authenticates the purchase transaction based upon the comparison outcome of the certificate and the F-PUF.

4. The method of claim 3, wherein:
the software application received from the purchase agent is signed with a private key of the purchase agent, and
the method further comprises retrieving a public key, from the nonvolatile memory, corresponding to the private key and validating the signed software application with the public key.

5. The method of claim 4, further comprising validating the signed software application prior to executing the software application.

6. The method of claim 1, further comprising:
communicating a message to the purchase agent, wherein
the certificate is received from the purchase agent in response to the message.

7. The method of claim 3, further comprising:
communicating a message to the purchase agent, wherein
the software application is received from the purchase agent in response to the message.

8. The method of claim 1, further comprising requesting a user of the mobile communication device to provide secure identification information, upon authenticating the purchase transaction.

9. The method of claim 8, wherein the secure identification information comprises biometric information of the user.

10. A mobile communication device that authenticates a purchase transaction, the mobile communication device comprising:
a nonvolatile memory comprising a Flash Physical Unclonable Function (F-PUF); and
a processor that retrieves the F-PUF from the nonvolatile memory, receives a certificate from a purchase agent, and authenticates the purchase transaction based upon a comparison outcome of the certificate and the F-PUF.

11. The mobile communication device of claim 10, wherein:
the certificate received from the purchase agent is signed with a private key of the purchase agent,
the nonvolatile memory stores a public key corresponding to the private key, and
the processor, prior to authenticating the purchase transaction, retrieves the public key from the nonvolatile memory and validates the signed certificate with the public key.

12. The mobile communication device of claim 10, wherein:
the processor:
receives a software application from the purchase agent; and
executes the received software application, and
the executed software application authenticates the purchase transaction based upon the comparison outcome of the certificate and the F-PUF.

13. The mobile communication device of claim 12, wherein:
the software application received from the purchase agent is signed with a private key of the purchase agent,
the nonvolatile memory stores a public key corresponding to the private key, and
the processor retrieves the public key from the nonvolatile memory and validates the signed software application with the public key.

14. The mobile communication device of claim 13, wherein the processor validates the signed software application prior to executing the software application.

15. The mobile communication device of claim 10, wherein the processor:
communicates a message to the purchase agent, and
receives the certificate from the purchase agent in response to the message.

16. The mobile communication device of claim 12, wherein the processor:
communicates a message to the purchase agent, and
receives the software application from the purchase agent in response to the message.

17. The mobile communication device of claim 10, wherein the processor requests a user of the mobile communication device to provide secure identification information, upon authenticating the purchase transaction.

18. The mobile communication device of claim 17, wherein the secure identification information comprises biometric information of the user.

19. A non-transitory computer readable medium comprising instructions that when executed by a processor of a mobile communication device cause the processor to implement a method of authenticating a purchase transaction, the method comprising:
receiving a certificate from a purchase agent; and
authenticating the purchase transaction based upon a comparison outcome of the certificate and a Flash Physical Unclonable Function (F-PUF) of a nonvolatile memory device integrated within the mobile communication device.

20. The medium of claim 19, wherein:
the certificate received from the purchase agent is signed with a private key of the purchase agent, and
the method further comprises, prior to authenticating the purchase transaction, retrieving a public key corresponding to the private key from the nonvolatile memory and validating the signed certificate with the public key.
